(19) United States
(12) Patent Application Publication
(10) Pub. No.: US 2007/0234373 A1
(43) Pub. Date: Oct. 4, 2007

(54) Field device managing system and field device managing method

(75) Inventors: Masahiro Ozaki, Tokyo (JP); Hiroshi Mori, Tokyo (JP)

Correspondence Address: EDWARDS ANGELL PALMER & DODGE LLP, P.O. BOX 55874, BOSTON, MA, 02205, US

(73) Assignee: Yokogawa Electric Corporation, Tokyo (JP)

(21) Appl. No.: 11/540,316

(22) Filed: Sep. 28, 2006

(30) Foreign Application Priority Data
Sep. 29, 2005 (JP) P.2005-284011

(51) Int. Cl. G06F 13/10

(52) U.S. Cl. 719/324

(57) ABSTRACT

A field device managing system for managing the field device performs communication with a field device by using application software. A virtual application mechanism obtains information for specifying an object application to start the object application and obtains information for specifying an object HART (highway addressable remote transducer) device to perform communication. A virtual driver mechanism receives the information for specifying the object HART device obtained by the virtual application mechanism to perform communication with the object HART device by the object application on the basis of the information.

This application claims foreign priority based on Japanese Patent application No. 2005-284011, filed Sep. 29, 2005, the content of which is incorporated herein by reference in its entirety.

### BACKGROUND OF THE INVENTION

1. Field of the Invention

The present invention relates to a field device managing system and a field device managing method for managing a field device by performing communication with the field device by using application software.

2. Description of the Related Art

A field device managing system has been known that performs a failure prediction, a maintenance scheduling, a maintenance management such as confirmation on a state of a device, and a monitoring, of a field device installed in a plant (for instance, see JP-A-2002-41139, and “Device Managing Package“PRM(Plant Resource Manager)””, Hiroshi MORI and other three members, Yokogawa Technical Journal, Yokogawa Electric Corporation, 2001, vol. 45, No. 3, p. 153-156).

On the other hand, as the field device, various kinds of HART (highway addressable remote transducer) devices advocated by HART Communication Foundation have been sold by various companies. The HART device can communicates with an external device by a signal obtained by superimposing a digital signal on an analog signal of 4-20 mA that has been the standard in the industry for a long time. The HART device communicates with a device-specific application, and the application is on a computer to manage parameters or the like. Especially, in adjustment or the like of the device having different methods for treating the parameters respectively for individual devices, such as a valve positioner, the device-specific application (application software) is necessarily used.

As shown in FIG. 5, a device-specific application 30 communicates with a HART device 5 by a HART signal via a HART modem 51 connected to a serial port (a COM port) on a computer. Though the structure and the function of the device-specific application 30 differ for providing vendors, typical examples are shown herein. The device-specific application 30 is connected to the HART device 5 through a general COM port driver 52 provided by the OS (operation system) of the computer and the HART modem 51. The HART modem 51 converts the HART signal and a serial signal (RS-232C).

When the above-described device-specific application 30 is operated in association with the field device managing system, as shown in FIG. 6, the device-specific application 30 is adapted to a plug-in application library interface provided by the field device managing system, and the adapted application is operated as a plug-in application 31 of the field device managing system.

A device managing client 20B functions as a user interface of the field device managing system. The plug-in application 31 carries out a function corresponding to the device-specific application 30. A plug-in application library 3 provides a communication interface to the HART device 5 and the information of a database, to the plug-in application 31. A field communication server 6 shown in FIG. 6 is a mechanism for communicating with the HART device 5 connected to a field control system. A database server 7 shown in FIG. 6 stores history information or the like in a secondary storage device 71.

The plug-in application 31 obtains a “device ID”, a “device tag” and a “device path” through a start argument (parameter) received from the device managing client 20B to communicate with the HART device 5 connected to a plant control system by using these. The “device ID” is an identifying number that is device-specific and the “device tag” is a logical name for identifying the device. The “device path” is path information to the HART device 5.

The device-specific application 30 is adapted to generate the plug-in application 31, so that the device-specific application 30 can be substantially used under an environment that the HART device 5 is connected to the field device managing system. Thus, all data can be advantageously managed unitary in the field device managing system.

However, in a method that the device-specific application 30 is adapted, since applications need to be adapted respectively for respective devices, a burden of development upon introducing the device or a burden for maintenance after the device is introduced is enormous.

### SUMMARY OF THE INVENTION

The present invention has been made in view of the above circumstances, and provides a field device managing system and a field device managing method that can greatly reduce a burden for development or maintenance by eliminating a necessity to adapt a device-specific application to a plug-in application for each device.

In some implementations, a field device managing system of the invention comprising:

at least one field device;

a user interface for performing communication with the field device by using an application software;
a virtual application section for obtaining information that specifies an object application software to start the object application software and obtaining information that specifies an object field device to perform communication; and

a virtual driver section for receiving the information that specifies the object field device, which is obtained by the virtual application section, and performing communication with the object field device by the object application software on the basis of the information.

In this field device managing system, the information for specifying the object application software is obtained to start the object application software and the information for specifying an object field device is received to perform a communication with the object field device by the object application software on the basis of the information. Accordingly, the field device can be managed without adapting the application software to a plug-in application.

In the field device managing system, the virtual driver section includes:

an analyzing section for analyzing the information from the object application software and information from the object field device; and

a serial port driver interface for transmitting and receiving the information between the analyzing section and the object application software, and

the virtual driver section operates as a serial port driver.

The object field device may be a HART device.

In some implementations, a field device managing method of the invention for managing at least one field device by performing communication with the field device by using an application software, the field device managing method comprising:

obtaining information that specifies an object application software to start the object application software;

obtaining information that specifies an object field device to perform communication; and receiving the obtained information that specifies the object field device and performing communication with the object field device by the object application software on the basis of the information.

In the field device managing method, the information for specifying the object application software is obtained to start the object application software and the information for specifying the object field device is received to perform communication with the object field device by the object application software on the basis of the information. Accordingly, the field device can be controlled without adapting the application software to a plug-in application.

The object field device may be a HART device.

### BRIEF DESCRIPTION OF THE DRAWINGS

FIG. 1 is a block diagram showing a structure of a field device managing system of an embodiment of the invention.

FIG. 2 is a flowchart showing an operation procedure of a virtual application mechanism.

FIG. 3 is a block diagram showing functions of a virtual driver mechanism.

FIG. 4 is a block diagram showing a structural example when a communication is carried out with a plurality of HART devices connected to a HART multiplexer.

FIG. 5 is a diagram showing a structural example for performing a communication with a field device by a device-specific application.

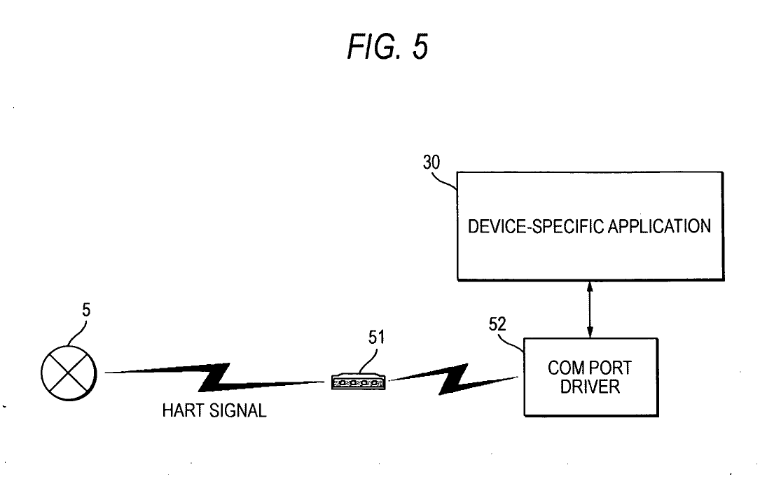

FIG. 6 is a diagram showing a structural example for performing a communication with a field device by a plug-in application.

### DESCRIPTION OF THE PRFERRED EMBODIMENTS

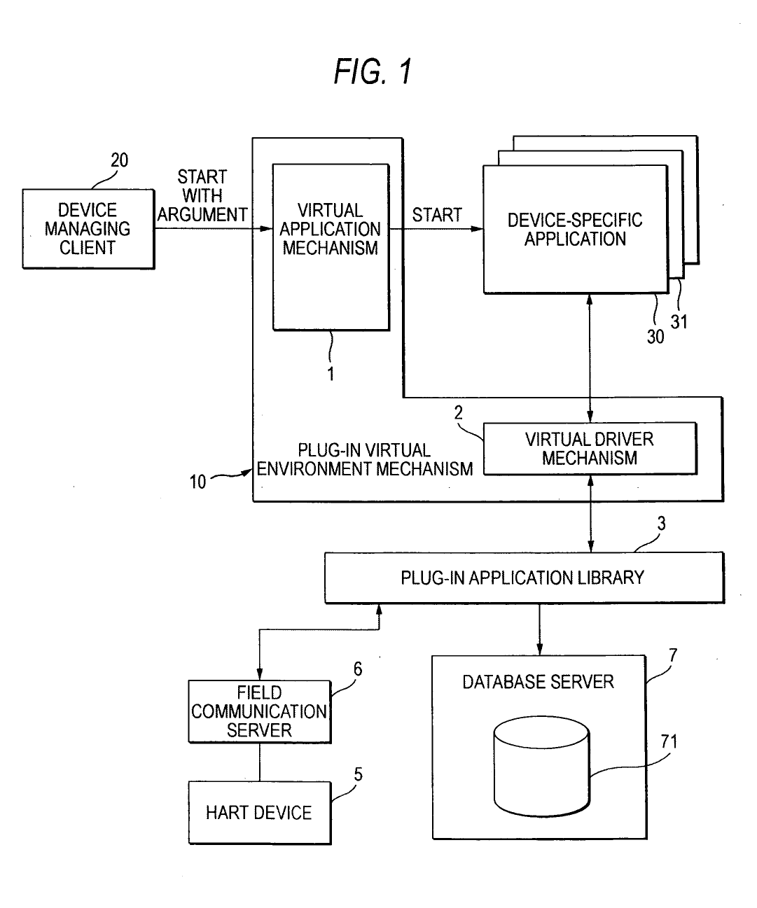

Now, referring to FIGS. 1 to 4, embodiments of a field device managing system according to the present invention will be described below.

FIG. 1 is a block diagram showing the structure of a field device managing system of one embodiment.

As shown in FIG. 1, in the field device managing system of this embodiment, a plug-in virtual environment mechanism is provided to eliminate a necessity for individually adapting a device-specific application (application software) for each device.

The plug-in virtual environment mechanism 10 includes a virtual application mechanism 1 (virtual application section) for receiving a request from a device managing client 20 and a virtual driver mechanism 2 (virtual driver section) operating as a COM port driver.

The device managing client 20 shown in FIG. 1 functions as a user interface of the field device managing system. A plug-in application library 3 provides a communication interface to a HART device 5 and the information of a database, to the plug-in virtual environment mechanism 10. A field communication server 6 is a mechanism for communicating with the HART device 5 connected to a field control system. The field control system is a system for automatically controlling the field device (including the HART device 5) disposed in a plant during the operation of the plant. A database server 7 stores history information or the like in a secondary storage device 71.

Now, an operation of the field device managing system will be described below.

When a device-specific application 30 is started, the device managing client 20 calls the virtual application mechanism 1 of the plug-in virtual environment mechanism 10 with a start argument. The start argument indicates a “device ID”, a “device tag” and a “device path” necessary for a communication with the HART device 5 as an object. The “device ID” is an identifying number which is specific to the HART device 5 and the “device tag” is a logical name for identifying the HART device 5. The “device path” is path information to the HART device 5.

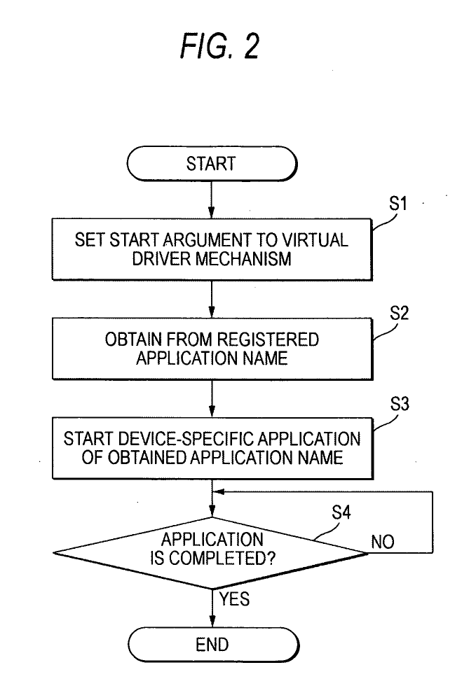

FIG. 2 is a flowchart showing an operation procedure of the virtual application mechanism 1. This process is started when the virtual application mechanism 1 receives the start argument (parameter).

In step S1 of FIG. 2, the virtual application mechanism 1 transmits the start argument received from the device managing client 20 to the virtual driver mechanism 2 of the plug-in virtual environment mechanism 10. In step S2, an application name specified by the start argument received from the device managing client 20 is obtained from registered application names. In step S3, the device-specific application 30 having the obtained application name is called to be started. In step S4, the completion of the started application 30 is waited and the processes are finished.

The device-specific application 30 that is started in the step S3 transmits a communication request to the virtual driver mechanism 2 of the plug-in virtual environment mechanism 10. The virtual driver mechanism 2 obtains the “device path” of the HART device 5 as an object of communication on the basis of the start argument received from the virtual application mechanism 1 to operate as the COM driver (a virtual driver). The virtual driver mechanism 2 accesses the HART device 5 connected to the field control system through the plug-in application library 3 as the COM driver.

In the above-described embodiment, the start argument is used to specify the HART device 5 as the object of communication. However, the virtual driver mechanism 2 may receive the “device path” for specifying the HART device 5 as the object of communication from many HART devices 5 connected to the field control system so that the virtual driver mechanism 2 can access the corresponding HART device 5. Thus, a method for specifying the HART device 5 is not limited to a specific method.

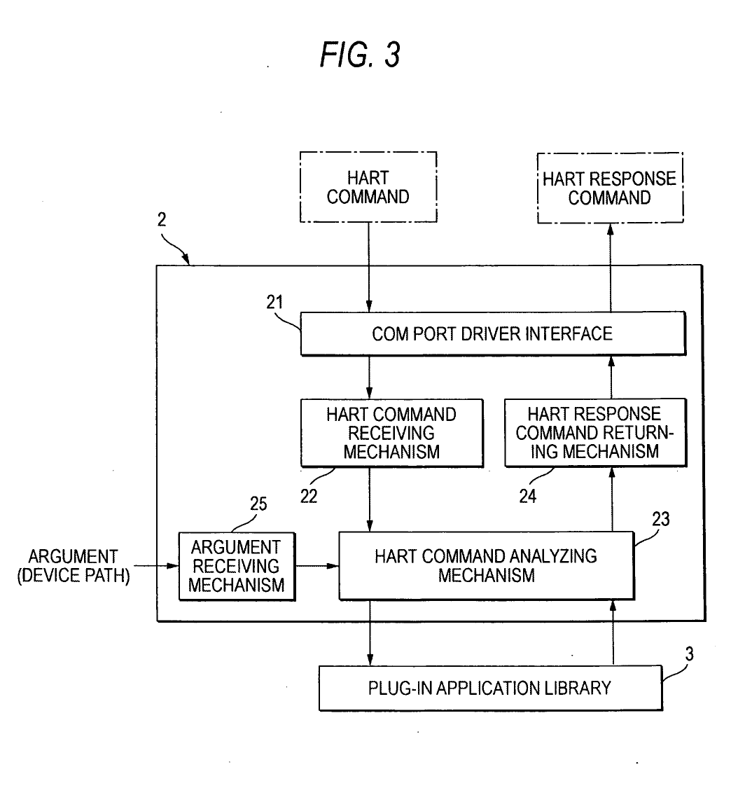

FIG. 3 is a block diagram showing functions of the virtual driver mechanism 2.

As shown in FIG. 3, the virtual driver mechanism 2 includes a COM port driver interface 2l (serial port driver interface) defined as a convention of OS, a HART command receiving mechanism 22 for receiving a command through the COM port driver interface 21, a HART command analyzing mechanism 23 (analyzing section) for analyzing the command received by the HART command receiving mechanism 22, a HART response command returning mechanism 24 for generating a HART response command on the basis of information from the HART device 5 side received by the HART command analyzing section 23, and an argument receiving mechanism 25 for receiving the start argument from the virtual application mechanism 1.

Since a plurality of codes for signal synchronization referred to as a preamble that is defined by a HART communication convention are continuously added to the HART command obtained through the COM port driver interface 21, the HART command receiving mechanism 22 deletes such unnecessary codes or checksums. After that, the contents of the HART command are analyzed by the HART command analyzing mechanism 23.

Though the detailed information of the HART command can be changed for each device, a basic structure including a format is defined by the HART communication convention. For instance, it is defined that, as for a command “41”, the device is allowed to perform a self-diagnosis, and, as for a command “48”, a result of a self-diagnosis is obtained from the device. In accordance with such a definition, the contents of the HART command are analyzed and the device path is previously received by the argument receiving mechanism 25, so that the HART command analyzing mechanism 23 can call the application 30 specific to the prescribed device (FIG. 1). For instance, processes such as leaving an operation history with respect to the HART device 5 and accessing the HART device 5 connected to the field control system can be performed in accordance with the HART command and the device path. Further, the HART command analyzing mechanism 23 receives the executed result. Thus, the HART response command returning mechanism 24 can conversely generate the HART response command to return the HART response command to the started application 30 (FIG. 1) that is specific to the prescribed device, through the COM port driver interface 21.

Information which is specific to the HART device and is different depending on kinds of devices is provided as a binary file by a convention advocated by the HART Communication Foundation. The information which is specific to the HART device includes HART command definition information (a detailed format or the definition information of parameters). The HART command analyzing mechanism 23 is provided with a mechanism that performs a process for analyzing the information which is specific to the HART device and taking out information required by a high-order application. The detailed information of the HART command that is different depending on the kinds of the HART devices is obtained so that a precise communication history can be advantageously left, and this mechanism can be used together in this embodiment.

As described above, in this embodiment, the plug-in virtual environment mechanism 10 having the virtual application mechanism 1 and the virtual driver mechanism 2 is provided. Therefore, a necessary application of a plurality of applications 30 that are specific to the devices can be operated without processing the individual applications 30. That is, the same operation as that when the plug-in application of each application 30 is generated is carried out through the device managing client 20, so that an arbitrary device-specific application 30 can be employed.

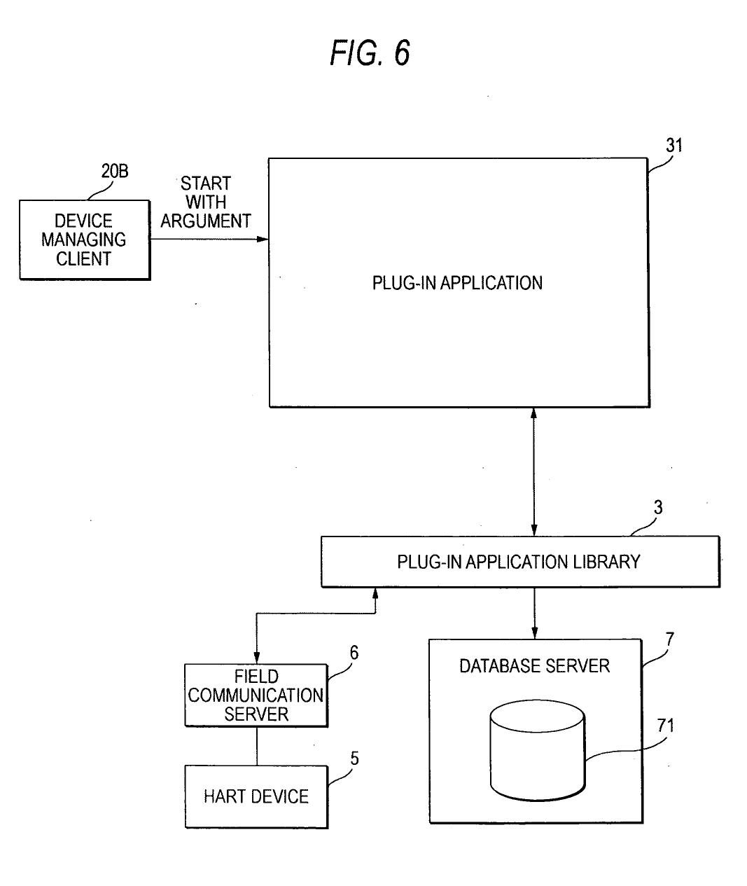

As described above, since the device-specific application 30 can be operated under a state as it is, a development is not necessary for individually adapting the application to the plug-in application for each device. Thus, a burden for development can be greatly reduced. Further, the device managing client 20, the plug-in application library 3, the field communication server 6 and the database server 7 (FIG. 6) do not need to be corrected.

Further, in a plug-in application 31 (FIG. 1) in which the device-specific application is already adapted to an individual plug-in application, the difference of the operation can be absorbed in the plug-in virtual environment mechanism like the device-specific application 30 that is not processed. Accordingly, even when the plug-in applications 31 are mixed therein, a problem does not arise. Any application can be made to function as an equivalent virtual application for the device managing client.

In FIG. 6, the device managing client 20B is provided with a mechanism for obtaining the names of the plug-in applications 31 originally registered to start the plug-in applications 31. Accordingly, the virtual application mechanism (FIG. 1) is previously registered in place of the plug-in application 31 so that the mechanism can be used. For instance, as a mounting example, a method may be considered that the data of the virtual application mechanism 1 is set to a registry for reading a value thereof upon starting.

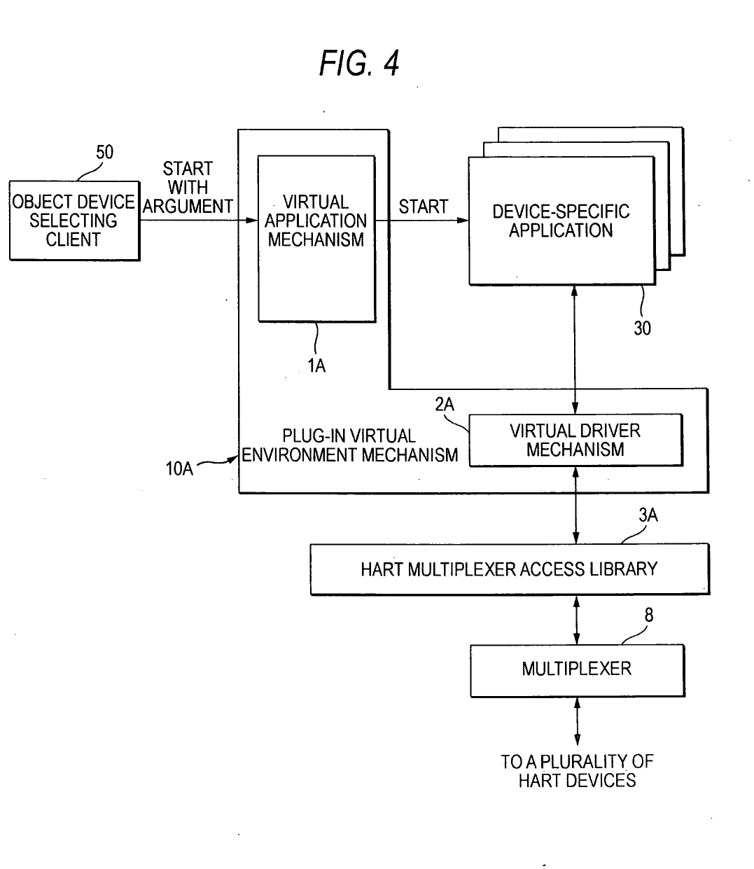

FIG. 4 is a block diagram showing a structural example when a communication is performed with a plurality of HART devices connected to a HART multiplexer.

As a communication method using the application peculiar to the device, there is a method for communicating with the plurality of HART devices connected to the HART multiplexer being sold at a market as well as a method for communicating with the HART device on the basis of 1 to 1 communication through a HART modem being sold at a market. The present invention is applied so that an application equivalent to an application that meets the HART multiplexer can be simply obtained without adapting the device-specific application that meets only the connection of the HART modem.

As shown in FIG. 4, a plurality of HART devices 5 are connected to a plug-in virtual environment mechanism 10A through a HART multiplexer 8 and a HART multiplexer access library 3A. The plug-in virtual environment mechanism 10A is provided with a virtual application mechanism 1A and a virtual driver mechanism 2A. Further, an object device selecting client 50 for specifying an object HART device 5 is provided. With such a structure, a communication with the plurality of HART devices 5 connected to the HART multiplexer 8 can be carried out without adapting an device-specific application 30.

In the example shown in FIG. 4, the object device selecting client 50 needs to be newly generated. However, an operator may merely input only information for specifying the object HART device 5 and a function may be merely required for employing the inputted information as a start argument to start the virtual application mechanism 1A. Further, the HART multiplexer access library 3A shown in FIG. 4 corresponds to the plug-in application library 3 shown in FIG. 1 and needs to be newly developed. However, the HART multiplexer access library is such a simple library as to provide a multiplexer command for selecting many HART devices 5 connected to the multiplexer 8. The virtual driver mechanism 2A shown in FIG. 4 adds a little correction to the virtual driver mechanism 2 shown in FIG. 1 so as to meet the HART multiplexer access library 3A. Accordingly, a burden for a development to obtain the structure shown in FIG. 4 is low.

As described above, in the structure shown in FIG. 4, since the plug-in virtual environment mechanism 10A having the virtual application mechanism 1A and the virtual driver mechanism 2A is provided, a necessary application of a plurality of applications 30 peculiar to the devices can be operated without processing the individual applications. Then, an arbitrary device of the plurality of HART devices 5 connected to the HART multiplexer 8 can be communicated with by the started application.

In the field device managing system of the present invention, the information for specifying the object application software is obtained to start the object application software and the information for specifying an object field device is received to perform communication with the object field device by the object application software on the basis of the information. Accordingly, the field device can be managed without adapting the application software to a plug-in application.

An applied scope of the present invention is not limited to the above-described embodiment. The present invention may be widely applied to systems for-managing field devices.

It will be apparent to those skilled in the art that various modifications and variations can be made to the described preferred embodiments of the present invention without departing from the spirit or scope of the invention. Thus, it is intended that the present invention cover all modifications and variations of this invention consistent with the scope of the appended claims and their equivalents.

What is claimed is:

1. A field device managing system comprising:
at least one field device;
a user interface for performing communication with the field device by using an application software;
a virtual application section for obtaining information that specifies an object application software to start the object application software and obtaining information that specifies an object field device to perform communication; and
a virtual driver section for receiving the information that specifies the object field device, which is obtained by the virtual application section, and performing communication with the object field device by the object application software on the basis of the information.

2. The field device managing system according to claim 1, wherein the virtual driver section includes:
an analyzing section for analyzing the information from the object application software and information from the object field device; and
a serial port driver interface for transmitting and receiving the information between the analyzing section and the object application software, and
the virtual driver section operates as a serial port driver.

3. The field device managing system according to claim 1, wherein the object field device is a HART (highway addressable remote transducer) device.

4. The field device managing system according to claim 2, wherein the object field device is a HART (highway addressable remote transducer) device.

5. A field device managing method for managing at least one field device by performing communication with the field device by using an application software, the field device managing method comprising:
obtaining information that specifies an object application software to start the object application software;
obtaining information that specifies an object field device to perform communication; and
receiving the obtained information that specifies the object field device and performing communication with the object field device by the object application software on the basis of the information.

6. The field device managing method according to claim 5, wherein the object field device is a HART (highway addressable remote transducer) device.
